(19) United States
(12) Patent Application Publication
(10) Pub. No.: US 2004/0139987 A1
(43) Pub. Date: Jul. 22, 2004

(54) Method for releasing and drying moveable elements of micro-electronic mechanical structures with organic thin film sacrificial layers

(76) Inventor: David J. Mount, North Andover, MA (US)

Correspondence Address: MAINE & ASMUS, 100 MAIN STREET, P O BOX 3445, NASHUA, NH, 03061-3445, US

(21) Appl. No.: 10/756,027

(22) Filed: Jan. 13, 2004

Related U.S. Application Data
(60) Provisional application No. 60/439,682, filed on Jan. 13, 2003.

(51) Int. Cl. B08B 3/12

(52) U.S. Cl. 134/1.3; 134/26; 134/30

(57) ABSTRACT

One embodiment of the present invention provides a method for the removal of organic sacrificial layers from a micro-electromechanical structure including the steps of: immersing the structure in at least one bath of at least a first organic solvent, thereby removing substantially all of the organic sacrificial layers; rinsing the structure in a bath of a second organic solvent; transferring the structure to a pressure chamber without substantial evaporation of the second organic solvent wherein the structure is immersed in a second bath of the second organic solvent; closing, pressurizing and filling the pressure chamber with liquid carbon dioxide whereby the second solvent is substantially displaced; heating the liquid carbon dioxide above its critical temperature, thereby permitting the carbon dioxide to undergo a phase change to the supercritical phase; venting the carbon dioxide to the atmosphere.

### RELATED APPLICATIONS

This application claims the benefit of U.S. Provisional Application No. 60/439,682, filed Jan. 13, 2003.

### FIELD OF THE INVENTION

The invention relates to method for the manufacture of microelectronic mechanical structures, and more particularly, to a method for the removal of organic thin film sacrificial layers from such structures using liquid phase organic solvents and supercritical drying techniques.

### BACKGROUND OF THE INVENTION

Integrated Circuits (IC's) and micro-electromechanical structure (MEMS) devices share a very similar sequence of fabrication steps. They differ in that the critical dimensions of IC's are usually much smaller than MEMS Devices and while IC's are static devices, MEMS Devices have miniature moving elements such as cantilevers, gears, pistons, that must be free to move, before the device is useful. These structures are first deposited as blanket thin films, and then subsequently defined using photolithographic and subtractive etching techniques. As in the fabrication of integrated circuits, elements are deposited on top of thin films that serve as a sacrificial film or layer. The sacrificial film is then removed, allowing the now defined moving element to be in free-space, except for a tether, which anchors some area of the moveable element to the substrate.

The most common sacrificial film (or, layer) used in MEMS Fabrication is Silicon Dioxide (SiO2). Known techniques exist for removing this sacrificial layer, notably by etching it with an aqueous solution of Hydrofluoric Acid, HF (aq). Various concentrations of HF are used, up to 49% by weight. After the sacrificial layer is removed, or etched away, the device must be thoroughly rinsed with de-ionized (DI) water, to rinse away any remaining HF. This rinse process leaves a meniscus of water in the free-space, between the element and the substrate. If this water is permitted to dry out in air, the surface tension that the evaporating water imparts to the moving element can cause liquid bridging, commonly called “stiction” to occur, the surface tension shrinking water droplet can draw the now movable element into contact with the substrate. If this occurs, the moving element may stick or fuse to the substrate. A stuck element is not repairable, or recoverable; and the MEMS device will not function. To avoid stiction, a drying method, involving the use of supercritical Carbon Dioxide, has been developed, known as critical point drying.

In critical point drying, after etching in HF and subsequent water rinsing the device is immersed in methanol, and allowed to soak for some time. Methanol, like other low molecular weight alcohols, is highly miscible in water, and any water remaining on the MEMS device is rapidly dissolved in the methanol. The device is then transferred to a pressure vessel; quickly, before the methanol evaporates. The pressure vessel is then sealed and liquid CO₂ is allowed to flow through the pressure vessel until all of the methanol/water has been displaced. The vessel is then filled and statically pressurized with liquid CO₂, which is then heated above its critical point. Above the critical values of 1070 psi and 31 degrees Centigrade, Carbon Dioxide undergoes a phase transformation, to what is known as the supercritical phase. In this phase, Carbon Dioxide, has “zero” surface tension, and when the pressure is released, stiction-free drying of the devices is enabled.

MEMS device technology has evolved to the point where the technology is utilized in numerous applications. Some of these applications, micro-optoelectronic mechanical structures, (MOEMS), for example, or MEMS devices used in optical applications, such as micro-mirror arrays, DWDM Filters, or laser prisms, etc., are constructed of materials, like aluminum, that would not resist acids. Therefore, these devices are fabricated using an organic sacrificial layer such as photo resists, or PMMA.

Unlike sacrificial SiO₂, organic sacrificial layers are not etched away with acids (i.e., HF). The most common method utilized to remove sacrificial organic films is with a technology known as plasma ashing, which is conducted by placing the MEMS devices in a vacuum-based, plasma ashing system. In this process, a reactive plasma is used. The plasma produces highly reactive mono-atomic Oxygen that subsequently reacts with the organic sacrificial layer, creating a volatile by-product that evolves from the surface of the device and is removed by a vacuum pumping system of the plasma ash system. Plasma ashing is intrinsically isotropic and will remove organic material under the moveable elements, thus freeing them. There are negative aspects of plasma ashing, these are: 1. temperature; the delicate elements can be subjected to temperatures of several hundred degrees Centigrade, 2. ashing is a combustion process which produces an “ash” residue; which can contaminate the devices, and 3. plasma ashing generates energetic ions which can bombard the moving elements and roughen the surface (i.e., micro-mirror arrays). Surface roughening is very deleterious to micro-optical devices.

What is needed, therefore, are techniques for effectively removing organic sacrificial layers with minimal residue and without damage to the delicate components of a micro-electronic mechanical device.

### BRIEF SUMMARY OF THE INVENTION

One embodiment of the present invention of the provides a method for the removal of organic sacrificial layers from a structure, that method comprising: immersing the structure in at least one bath of at least one organic cleaning solvent, thereby removing substantially all of the organic sacrificial layers; rinsing the structure in a bath of an organic rinse solvent; transferring the structure to a pressure chamber without substantial evaporation of the organic rinse solvent wherein the structure is immersed in a second bath of the rinse organic solvent; treating the structure with a process fluid in a supercritical phase in the pressure chamber, displacing the organic rinse solvent; and exhausting the process fluid.

A further embodiment of the present invention provides a method for the removal of organic sacrificial layers from a micro-electromechanical structure including: immersing the structure in at least one bath of at least a first organic solvent, thereby removing substantially all of the organic sacrificial layers; rinsing the structure in a bath of a second organic solvent; transferring the structure to a pressure chamber without substantial evaporation of the second organic solvent wherein the structure is immersed in a second bath of the second organic solvent; closing, pressurizing and filling the pressure chamber with liquid carbon dioxide whereby the second solvent is substantially displaced; heating the liquid carbon dioxide above its critical temperature, thereby permitting the carbon dioxide to undergo a phase change to the supercritical phase; venting the carbon dioxide to the atmosphere.

Another embodiment of the present invention provides a method for the removal of organic sacrificial layers from a micro-electromechanical structure. That method includes: immersing the structure into a first bath of a first solvent; subjecting the first bath to ultrasonic agitation; removing the structure from the first bath and immersing the structure in a second bath of a second solvent; agitating the second bath using ultrasonic pulses; transferring the structure to a third bath of a third solvent; agitating the third bath using ultrasonic pulses; and transferring the structure to a fourth bath of a fourth solvent.

Yet another embodiment of the present invention provides such a method with the further steps of: placing the structure in a bath of the fourth solvent within a pressure chamber; filling the pressure chamber with liquid carbon dioxide; heating the carbon dioxide above its critical point; depressurizing the pressure chamber.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a method for the removal of sacrificial layers from a structure configured according to one embodiment of the present invention.

FIG. 2 is a block diagram of a method for the removal of sacrificial layers from a structure configured according to one embodiment of the present invention illustrating the use of a plurality cleaning solvents prior to drying.

### DETAILED DESCRIPTION OF THE INVENTION

One embodiment of the present invention provides a sequential wet-dry release process for organic sacrificial layers used in the production of micro-electronic mechanical devices; whereby MEMS devices, nanostructures, nanofabricated devices, and other such structures are immersed in a sequence of liquid phase organic solvents and deionized water, in tanks, or vessels, in which the fluid in the vessel is agitated by ultrasonic, acoustic energy. The devices are then transferred to a pressure vessel and dried with a Critical Point drying process that employs supercritical Carbon Dioxide as the drying agent. The entire process (wet-to-dry) is conducted in a benign temperature regime of not greater than 40 degrees Centigrade, leaves no residues and does not roughen surface finishes.

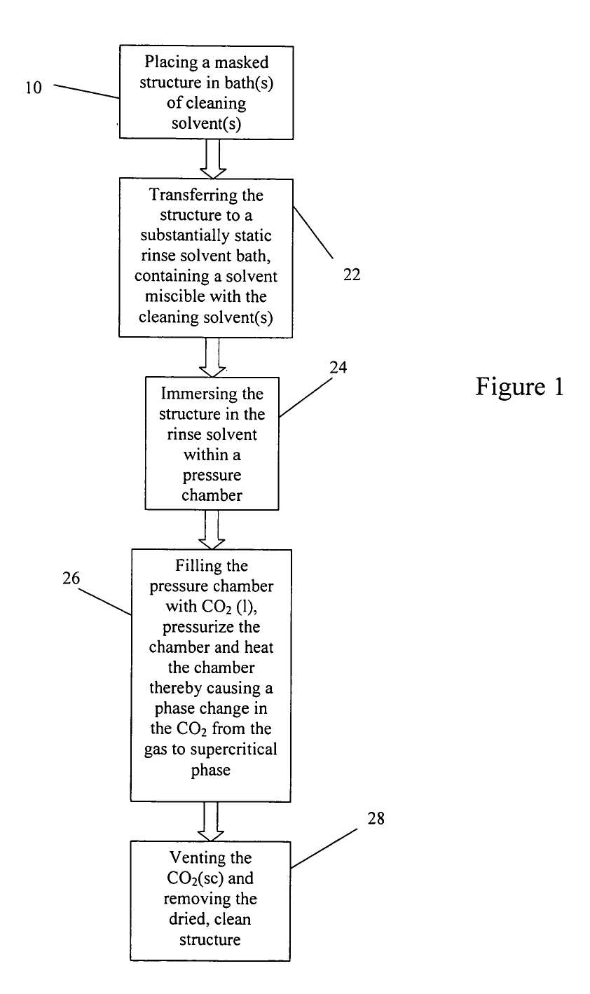

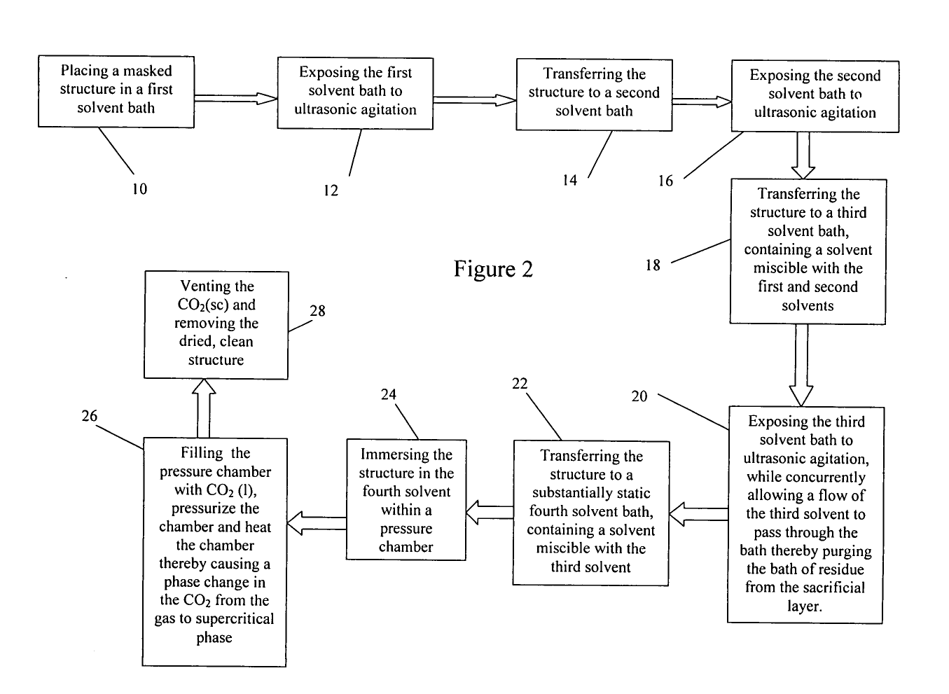

The release process sequence, illustrated in FIGS. 1 and 2, according to one embodiment of the present invention comprises a “wet” step wherein a series of low molecular weight, liquid phase, organic solvents are used to remove the organic sacrificial layer. The time that the device must be exposed to each solvent is dependant on the material of which the sacrificial layer is composed, more resistant materials must be exposed longer to the solvents, or to more aggressive solvents to thoroughly dissolve the sacrificial layer. In one embodiment, illustrated in FIG. 2 the device is introduced to a bath of methanol 10 and may be exposed to ultrasonic agitation 12. The device is then transferred to a bath of acetone 14, where it is immersed and may be exposed to ultrasonic agitation 16. Ultrasonic agitation insures rapid dissolution of the layer by the introduction of mechanical energy into the solvent system. The force of the ultrasonic agitation input may vary as a function of the fragility of the moving elements of the device, so as to prevent damage to the devices. After exposure to acetone 14,16, the sacrificial layer will be completely dissolved, thus freeing the movable elements. The acetone and dissolved organic film is then rinsed from the device with, according to one embodiment, clean distilled water, by immersing the devices in the water 18 and applying ultrasonic agitation 20. Complete water rinsing is accomplished by allowing the water to overflow the vessel while applying low-powered, ultrasonic energy. In alternative embodiments, an organic solvent miscible with both acetone and methanol may be used in place of de-ionized, distilled, or purified water. Finally the device is, according to one embodiment of the present invention, transferred to, and immersed in a bath of methanol in a static vessel 22. The static methanol bath will absorb or dissolve any water remaining on the device, thereby facilitating the removal of that water and preparing the device for critical point drying with supercritical carbon dioxide.

According to one embodiment of the present invention, the device, still “wet” with methanol, is transferred to a pressure vessel rapidly, so as to limit the amount of methanol evaporation in air. In the pressure vessel, the device is completely immersed in methanol 24. According to one embodiment of the present invention, the pressure vessel is then sealed and the critical point drying sequence using supercritical carbon dioxide is carried out 26. As described in the background, the pressure vessel is then sealed and liquid CO₂ is allowed to flow through the pressure vessel until all other solvents have been displaced. The vessel is filled and statically pressurized with liquid CO₂, which is then heated above its critical point. Above the critical values of 1070 psi and 31 degrees Centigrade, carbon dioxide undergoes a phase transformation, to the supercritical phase. After the drying process has been completed and the CO₂ in the pressure vessel has been vented, the MEMS devices can be extracted. The movable elements are completely free to move, with no liquid-bridging (stiction) in evidence, substantially free of residues and without surface finish damage.

Ones skilled in the chemical arts will readily appreciated that other organic solvents may be used, and that methanol and acetone are used as examples. When selecting a solvent in accord with an embodiment of the present invention, one may consider factors such as effectiveness, aggressiveness of the solvent, acquisition, storage and disposal costs, environmental impact, worker safety and carcinogenicity associated with particular solvents.

One skilled in the art will likewise readily appreciate that while the method has heretofore been described with respect to the manufacture MEMS devices, other devices and components having similar manufacturing processes may likewise be cleaned in accord with the various embodiments of the present invention.

As illustrated in FIG. 1, another embodiment of the present invention provides for the placement of the structure having a sacrificial layer in a bath of at least one organic cleaning solvent 10. This cleaning solvent may be a solvent or cocktail of organic solvents having a low molecular weight, and favorable properties for the removal of the sacrificial layer. According to various embodiments, it may be one or more solvents selected from the group comprising methanol, acetone, methylethylketone, low molecular weight alcohols, low molecular weight ketones, low molecular weight aromatics, low molecular weight alkanes, low molecular weight alkenes, low molecular weight polar organics, low molecular weight non-polar organics, and combinations thereof. As noted above, a number of factors may effect the decision of one skilled in the art to select one solvent over another. The structure may be transferred between any number such baths until the sacrificial layer has been removed. The solvent may, in some embodiments be agitated, thereby speeding the dissolution process and dislodging parts of the sacrificial layer. This agitation may be achieved using ultrasonic pulses or other known agitation methods.

The structure may then be placed in a bath of rinsing solvent 22. In one embodiment of the present invention, the rinsing solvent may be the same solvent as the cleaning solvent or may be another solvent miscible with the cleaning solvent. The structure is immersed in the rinse solvent, and the rinse solvent is permitted to dissolve residue of the cleaning solvent(s) remaining on the structure.

The structure, still coated or “wet” with rinse solvent, is transferred to a rinse solvent bath located in a pressure chamber and immersed in the rinse solvent 24. This wet transfer and immersion prevents stiction from occurring at this point, which might otherwise occur should substantial evaporation be permitted. As in the embodiment illustrated in FIG. 2, a critical point drying sequence using supercritical carbon dioxide, or other such supercritical phase fluid is carried out 26. As described in the background, the pressure vessel is then sealed and liquid CO₂ or other process fluid is allowed to flow through the pressure vessel until all other solvents have been displaced. The vessel is filled and statically pressurized with liquid CO₂, which is then heated above its critical point. Above the critical values of 1070 psi and 31 degrees Centigrade, carbon dioxide undergoes a phase transformation, to the supercritical phase. Alternatively, the process fluid flow may be introduced in a supercritical phase. After the drying process has been completed and the CO₂ in the pressure vessel has been vented, the MEMS devices can be extracted 28.

According to one embodiment of the present invention, this critical point drying process may be performed in a system similar to that disclosed and claimed in U.S. Pat. No. 6,067,728, issued to Farmer et al., which is hereby incorporated in its entirety by reference. In such an embodiment, the structure is submerged in a low molecular weight alcohol or other solvent miscible with a process fluid such as CO₂ (l), in a horizontally oriented cavity of uniform diameter and constant vertical depth in the base of a pressure vessel comprising the base and a lid. The lid is placed on the base, and clamped in place with two locking clamp rings, each ring having an open jaw sufficiently large to partially enclose an edge of the pressure vessel. The rings are, in one embodiment, located on opposite sides of the vessel, which is configured with top and bottom tapered cam plates, those cam plates may be oriented with respect to the rollers so as to bring the rings into vertically compressive locking engagement on the vessel when the rings are moved into the locking position. A through flow of process fluid, such as, but not limited to, liquid carbon dioxide, CO₂ (l) until the rinse and cleaning fluids are displaced. Alternatively the process fluid may be introduced to the cavity in a supercritical phase at supercritical temperature and pressure, releasing the process fluid from the closed cavity, unclamping the lid from the base, removing the lid from the base, and removing the structure from the now open cavity

One embodiment of the present invention provides a method for the removal of organic sacrificial layers from a structure, the method comprising: immersing the structure in at least one bath of at least one organic cleaning solvent, thereby removing substantially all of the organic sacrificial layers; rinsing the structure in a bath of an organic rinse solvent; transferring the structure to a pressure chamber without substantial evaporation of the organic rinse solvent wherein the structure is immersed in a second bath of the rinse organic solvent; introducing a process fluid into the pressure chamber and displacing the organic rinse solvent with the process fluid; sealing and pressurizing the pressure chamber with the process fluid; heating the process fluid above its critical temperature, thereby permitting the process fluid to undergo a phase change to a supercritical phase; venting the process fluid.

Such a method may be conducted at temperatures of less than 40 degrees centigrade. These organic cleaning and rinse solvents may be at least one organic solvent selected from the group of semi-volatile organic solvents. While the step of immersing the structure in at least one bath of at least one organic cleaning solvent, thereby removing substantially all of the organic sacrificial layers comprises: immersing the structure into a first bath of a first solvent; subjecting the first bath to ultrasonic agitation; removing the structure from the first bath and immersing the structure in a second bath of a second solvent; agitating the second bath using ultrasonic pulses; transferring the structure to a third bath of a third solvent; and agitating the third bath using ultrasonic pulses.

Another embodiment of the present invention provides a method for the removal of organic sacrificial layers from a structure, the method comprising: immersing the structure into a first bath of a first solvent; subjecting the first bath to ultrasonic agitation; removing the structure from the first bath and immersing the structure in a second bath of a second solvent; agitating the second bath using ultrasonic pulses; transferring the structure to a third bath of a third solvent; agitating the third bath using ultrasonic pulses while flowing a supply of the third solvent over the structure; and transferring the structure to a fourth bath of a fourth solvent.

Such a method may also comprise: placing the structure in a bath of the fourth solvent within a pressure chamber; filling the pressure chamber with liquid carbon dioxide; heating the carbon dioxide above its critical point; depressurizing the pressure chamber and exhausting the carbon dioxide. In such a method the first, second, and fourth solvents comprise organic solvents. The first solvent may be methanol, second solvent may be acetone, third solvent may be water, while the fourth solvent may be methanol.

Another embodiment of the present invention provides a method for the removal of organic sacrificial layers from a structure, that method comprising: immersing the structure in at least one bath of at least one organic cleaning solvent, thereby removing substantially all of the organic sacrificial layers; rinsing the structure in a bath of an organic rinse solvent; transferring the structure to a pressure chamber without substantial evaporation of the organic rinse solvent wherein the structure is immersed in a second bath of the rinse organic solvent; treating the structure with a process fluid in a supercritical phase in the pressure chamber, displacing the organic rinse solvent; and exhausting the process fluid.

In such a method treating the structure with a process fluid in a supercritical phase in the pressure chamber, displacing the organic rinse solvent may comprise: introducing a process fluid into the pressure chamber and displacing the organic rinse solvent with the process fluid; sealing and pressurizing the pressure chamber with the process fluid; heating the process fluid above its critical temperature, thereby permitting the process fluid to undergo a phase change to a supercritical phase; and venting the process fluid.

Alternatively, treating the structure with a process fluid in a supercritical phase in the pressure chamber, displacing the organic rinse solvent comprises: introducing a through flow of a supercritical phase process fluid; stopping the through flow; and exhausting the process fluid from the pressure chamber.

Such a process of treating the structure with a process fluid in a supercritical phase in the pressure chamber, displacing the organic rinse solvent comprises: placing a lid on a base of the pressure chamber, the base having a cavity wherein is disposed the structure; clamping the lid to the base with two slidable locking clamp rings, each ring having an open jaw sufficiently large to partially enclose an edge of the vessel, the chamber configured with top and bottom cam plates, the cam plates oriented with respect to the rings to bring the rings into vertically compressive locking engagement on the chamber when the rings are moved into the locking position; introducing a through flow of process fluid in the cavity at supercritical temperature and pressure; exhausting the process fluid from the closed cavity; unclamping the lid from the base; removing the lid from the base; and removing the structure from the cavity.

In such a method, a structure is immersed in a plurality of organic cleaning solvent baths, each of the organic cleaning solvent bath containing a different organic cleaning solvent. The different organic cleaning solvents is at least one solvent selected from the group of solvents consisting of methanol, acetone, methylethylketone, low molecular weight alcohols, low molecular weight ketones, low molecular weight aromatics, low molecular weight alkanes, low molecular weight alkenes, low molecular weight polar organics, and low molecular weight non-polar organics. In some embodiments the process fluid is carbon dioxide, the organic rinse solvent may be miscible with the process fluid or organic rinse solvent may be the same as at least one organic cleaning solvent.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for the removal of organic sacrificial layers from a structure, said method comprising:
immersing said structure in at least one bath of at least one organic cleaning solvent, thereby removing substantially all of said organic sacrificial layers;
rinsing said structure in a bath of an organic rinse solvent;
transferring said structure to a pressure chamber without substantial evaporation of said organic rinse solvent wherein said structure is immersed in a second bath of said rinse organic solvent;
introducing a process fluid into said pressure chamber and displacing said organic rinse solvent with said process fluid;
sealing and pressurizing said pressure chamber with said process fluid;
heating said process fluid above its critical temperature, thereby permitting said process fluid to undergo a phase change to a supercritical phase; and
venting said process fluid.

2. The method of claim 1 wherein said method is conducted at temperatures of less than 40 degrees centigrade.

3. The method of claim 1 wherein said organic cleaning and rinse solvents are at least one organic solvent selected from the group of semi-volatile organic solvents.

4. The method of claim 1 wherein said step of immersing said structure in at least one bath of at least one organic cleaning solvent, thereby removing substantially all of said organic sacrificial layers comprises:
immersing said structure into a first bath of a first solvent;
subjecting said first bath to ultrasonic agitation;
removing said structure from said first bath and immersing said structure in a second bath of a second solvent;
agitating said second bath using ultrasonic pulses;
transferring said structure to a third bath of a third solvent; and
agitating said third bath using ultrasonic pulses.

5. A method for the removal of organic sacrificial layers from a structure, the method comprising:
immersing said structure into a first bath of a first solvent;
subjecting said first bath to ultrasonic agitation;
removing said structure from said first bath and immersing said structure in a second bath of a second solvent;
agitating said second bath using ultrasonic pulses;
transferring said structure to a third bath of a third solvent;
agitating said third bath using ultrasonic pulses while flowing a supply of said third solvent over said structure; and
transferring said structure to a fourth bath of a fourth solvent.

6. The method of claim 5 further comprising the steps of:
placing said structure in a bath of said fourth solvent within a pressure chamber;
filling said pressure chamber with liquid carbon dioxide;
heating said carbon dioxide above its critical point; and
depressurizing said pressure chamber and exhausting said carbon dioxide.

7. The method of claim 5 wherein said first, second, and fourth solvents comprise organic solvents.

8. The method of claim 5 wherein said first solvent is methanol.

9. The method of claim 5 wherein said second solvent is acetone.

10. The method of claim 5 wherein said third solvent is water.

11. The method of claim 5 wherein said fourth solvent is methanol.

12. A method for the removal of organic sacrificial layers from a structure, said method comprising:
immersing said structure in at least one bath of at least one organic cleaning solvent, thereby removing substantially all of said organic sacrificial layers;
rinsing said structure in a bath of an organic rinse solvent;
transferring said structure to a pressure chamber without substantial evaporation of said organic rinse solvent wherein said structure is immersed in a second bath of said rinse organic solvent;
treating said structure with a process fluid in a supercritical phase in said pressure chamber, displacing the organic rinse solvent; and
exhausting the process fluid.

13. The method according to claim 12 wherein treating said structure with a process fluid in a supercritical phase in said pressure chamber, displacing the organic rinse solvent comprises:
introducing a process fluid into said pressure chamber and displacing said organic rinse solvent with said process fluid;
sealing and pressurizing said pressure chamber with said process fluid;
heating said process fluid above its critical temperature, thereby permitting said process fluid to undergo a phase change to a supercritical phase; and
venting said process fluid.

14. The method of claim 12 wherein treating said structure with a process fluid in a supercritical phase in said pressure chamber, displacing the organic rinse solvent comprises:
introducing a through flow of a supercritical phase process fluid;
stopping said through flow; and
exhausting said process fluid from said pressure chamber.

15. The method of claim 12 wherein treating said structure with a process fluid in a supercritical phase in said pressure chamber, displacing the organic rinse solvent comprises:
placing a lid on a base of said pressure chamber, said base having a cavity wherein is disposed said structure;
clamping said lid to said base with two slidable locking clamp rings, each said ring having an open jaw sufficiently large to partially enclose an edge of said vessel, said chamber configured with top and bottom cam plates, said cam plates oriented with respect to said rings to bring said rings into vertically compressive locking engagement on said chamber when said rings are moved into said locking position;
introducing a through flow of process fluid in said cavity at supercritical temperature and pressure;
exhausting said process fluid from said closed cavity;
unclamping said lid from said base;
removing said lid from said base; and
removing said structure from said cavity.

16. The method according to claim 12 wherein said structure is immersed in a plurality of organic cleaning solvent baths, each said organic cleaning solvent bath containing a different organic cleaning solvent.

17. The method according to claim 16 wherein said different organic cleaning solvents is at least one solvent selected from the group of solvents consisting of methanol, acetone, methylethylketone, low molecular weight alcohols, low molecular weight ketones, low molecular weight aromatics, low molecular weight alkanes, low molecular weight alkenes, low molecular weight polar organics, and low molecular weight non-polar organics.

18. The method according to claim 12 wherein said process fluid is carbon dioxide.

19. The method according to claim 12 wherein said organic rinse solvent is miscible with said process fluid.

20. The method according to claim 12 wherein said organic rinse solvent is the same as at least one said organic cleaning solvent.
